(19) United States
(12) Patent Application Publication
(10) Pub. No.: US 2024/0169271 A1
(43) Pub. Date: May 23, 2024

(54) MACHINE LEARNING MODEL MANAGEMENT

(71) Applicant: BRITISH TELECOMMUNICATIONS PUBLIC LIMITED COMPANY, London (GB)

(72) Inventors: Johannes NOPPEN, London (GB); Panagiotis KOUROUKLIDIS, London (GB); Alistair MCCORMICK, London (GB)

(21) Appl. No.: 18/551,461

(22) PCT Filed: Mar. 10, 2022
(86) PCT No.: PCT/EP2022/056225

§ 371 Date: Sep. 20, 2023

(30) Foreign Application Priority Data
Mar. 22, 2021 (GB) 2103918.5

(51) Int. Cl. G06N 20/00

(52) U.S. Cl. CPC G06N 20/00

(57) ABSTRACT

A computer implemented method for operating a software application including a trained machine learning model, the method comprising: receiving one or more rules for measuring a fitness of the machine learning model according to a predetermined specification of fitness; identifying one or more model data parameters derivable from the machine learning model required for execution of the rules; retrieving the identified 0 parameters; executing the rules to determine a measure of fitness of the machine learning model; and responsive to a determination that the measure of fitness meets a predetermined threshold measure to indicate insufficient fitness, performing one or more adjustments to the application such that a measure of fitness of the machine learning model meets a predetermined threshold measure to indicate sufficient fitness.

### PRIORITY CLAIM

The present application is a National Phase entry of PCT Application No. PCT/EP2022/056225, filed Mar. 10, 2022, which claims priority from GB Patent Application No. 2103918.5, filed Mar. 22, 2021, each of which is hereby fully incorporated herein by reference.

### TECHNICAL FIELD

The present disclosure relates to the management of machine learning models.

### BACKGROUND

Artificial intelligence (AI) can be implemented by machine learning models applied in software to address a problem domain. The selection of a machine learning model and its configuration depends upon the problem domain and the effectiveness of the model for addressing the problem. Features of machine learning models are multidimensional and include architectural selections (such as type(s) of algorithm(s) (e.g. regressor or classifier, long-short-term-memory, deep neural network, convolutional neural network etc.), extent of supervision in training data, training technique and the like). Also, features include hyperparameters such as learning rate, layer depth, neuron function (e.g. linear, step, sigmoid, rectifier), adjustment factors and functions, iterations, stopping conditions, and a multitude of other configurable parameters.

Machine learning models generally serve to model an ideal function ƒ having a domain x and range ƒ(x), and are particularly suitable where the precise specification of such a function ƒ is not readily defined using formal specifications and/or software. For example, a function ƒ for processing diverse image data in its domain to map to classes of image in its range may not be readily specified in, for example, imperative programming. In particular, such a function is especially challenging to define in view of the extremely wide-ranging nature of the input domain. Thus, machine learning models are trained based on training data to approximate the ideal function ƒ.

As an approximation of the ideal function ƒ, a machine learning model is fit for purpose only in accordance with its accuracy of approximation and/or in accordance with any degree of acceptable tolerance of the approximation depending on its application. For example, a machine learning model applied to a speech recognition system that makes errors in 5% of recognition cases may be tolerable, whereas a machine learning model applied to a self-driving vehicle that makes errors in 0.01% of recognition cases may be intolerable. Furthermore, it is conceivable that the data domain for a machine learning model adjusts over time, such as in response to the performance of the machine learning model itself. For example, input data may adapt to reflect the performance, efficacy, accuracy or other characteristic of the machine learning model. An example of this is adjustments to application inputs such as spoken words in a speech recognition application, written characters in a handwriting recognition application, driver behavior in a vehicle assistance application, image selection in an image recognition application and other similar adjustments depending on application as will be apparent to those skilled in the art. By way of illustration, a user may adjust how they write handwritten characters in a handwriting recognition system in response to the user's experience of the efficacy of the handwriting recognition system.

Thus, the ideal function ƒ is itself not constant where the tolerance for accuracy of a machine learning approximation and/or changes to the data context such as the domain of the function occur. Accordingly, machine learning models can exhibit reduced efficacy and/or suitability over time. It would be advantageous to address this challenge.

### SUMMARY

According to a first aspect of the present disclosure, there is provided a computer implemented method for operating a software application including a trained machine learning model, the method comprising: receiving one or more rules for measuring a fitness of the machine learning model according to a predetermined specification of fitness; identifying one or more model data parameters derivable from the machine learning model required for execution of the rules; retrieving the identified parameters; executing the rules to determine a measure of fitness of the machine learning model; and responsive to a determination that the measure of fitness meets a predetermined threshold measure to indicate insufficient fitness, performing one or more adjustments to the application such that a measure of fitness of the machine learning model meets a predetermined threshold measure to indicate sufficient fitness.

In some embodiments, adjusting the application includes one of: retraining the machine learning model; replacing the machine learning model; further training the machine learning model; and identifying the machine learning model as unfit.

In some embodiments, the one or more rules are adapted periodically. In some embodiments, the model data parameters include one or more of: outputs of the machine learning model; inputs and outputs of the machine learning model; and characteristics of the machine learning model.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement to operate a software application in accordance with embodiments of the present disclosure.

FIG. 3 is a flowchart of a method to operate a software application in accordance with embodiments of the present disclosure.

### DETAILED DESCRIPTION

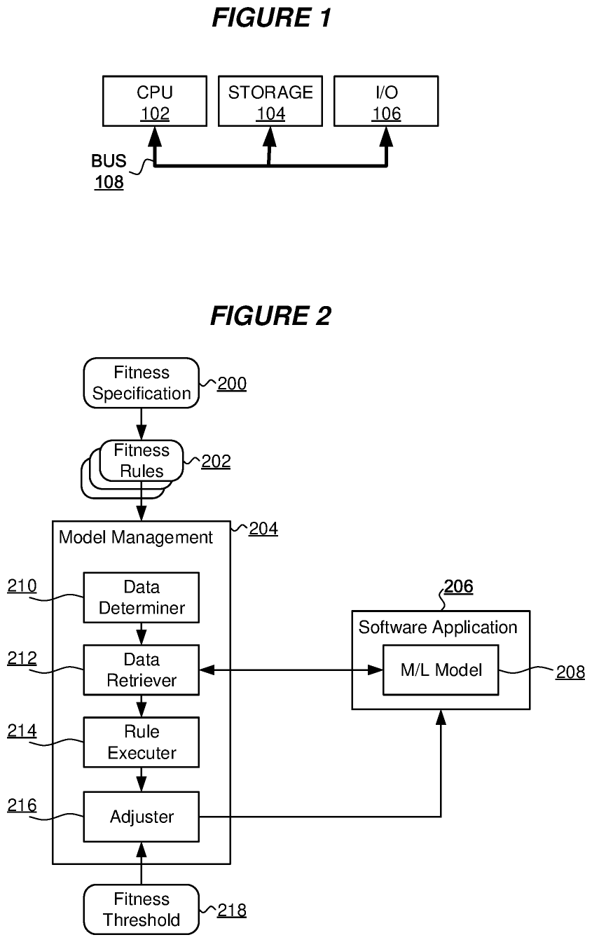

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement to operate a software application 206 in accordance with embodiments of the present disclosure. The software application 206 includes a trained machine learning model 208 such as a machine learning model trained based on supervised training data to approximate a function ƒ to map an input domain x to the range ƒ(x). Any suitable machine learning algorithm may be employed by the machine learning model 208 as will be apparent to those skilled in the art. A fitness specification 200 is a specification of fitness of the machine learning model 208 such as a specification of required characteristics of the machine learning model. For example, the fitness specification 200 can define exemplary mappings expected of the machine learning model such as mappings of specific, generalized or exemplary inputs to outputs of the model. Additionally or alternatively the fitness specification can include a definition of limits, constraints or other characteristics of the machine learning model suitable for the formulation of fitness rules 202 as executable rules on which basis a fitness of the machine learning model 208 can be measured vis-à-vis the fitness specification 200. For example, the fitness specification 200 can include a definition of one or more required outputs of the machine learning model 208 in respect of one or more defined inputs to the model 208 and an indication of a proportion of outputs of the model 208 that must correspond to the required outputs, such as a percentage accuracy or similar. The fitness rules 202 thus can be defined as executable rules to test such a specification by execution of the machine learning model 208 to measure fitness of the model 208 in terms of an extent of compliance of the model 208 with the requirements of the test 202, such as a proportion of the tests 202 that are successful. Additional and/or alternative specification 200 requirements and corresponding fitness rules 202 can be employed including, inter alia, for example: rules defining requirements for all outputs of the model 208 such as minimum and/or maximum proportions, ratios or the like of classifications of the model 208 in use; performance characteristics of the machine learning model 208 such as speed of operation, latency and the like; expected characteristics of the machine learning model 208 such as number and/or nature of output classes, a degree of tolerance of approximation of the model with an ideal function ƒ measured, for example, by use of exemplary input data for the model 208; and other requirements as will be apparent to those skilled in the art. Thus, a measure of the fitness of the machine learning model 208 is determinable on the basis of the fitness rules 202 that are defined to test characteristics of the machine learning model 208 against expected characteristics indicated in the fitness specification 200.

A model management component 204 is provided as a hardware, firmware, software or combination component arranged to monitor and adjust the software application 206. The model management component 204 includes a data determiner as a hardware, firmware, software or combination component arranged to receive the fitness rules 202 and to determine one or more model data parameters derivable from the machine learning model 208 required for execution of the rules 202. For example, the rules 202 can require data from the model 208 such as, inter alia: outputs of the machine learning model, such as outputs for given inputs including inputs that may be specified as part of the rules 202; inputs and outputs of the machine learning model; and characteristics of the machine learning model such as those described above. Such data thus constitutes parameters for the execution of the fitness rules 202. The model management component 204 further includes a data retriever component as a hardware, software, firmware or combination component arranged to retrieve data from the machine learning model 208 in accordance with the data parameters identified by the data determiner 210.

The model management component 204 further includes a rule executer 214 as a hardware, software, firmware or combination component operable to execute one or more of the fitness rules 202 to determine a measure of fitness of the machine learning model 208. The rule executer 214 thus executes the rules 202 received by the data determiner 210 on the basis of data for the model 208 retrieved by the data retriever 212 and executes the rules 202 on the basis of the retrieved data. The rule executer 214 thus determines a measure of fitness for the machine learning model 208 based on the results of executing the rules 202. Measures of fitness can be discrete indications such as a binary “fit” or “unfit” indication, or can correspond to continuous, partly-continuous or bounded-continuous measures such as measures of rates, proportions, ratios or other measures in respect of characteristics of the operation or nature of the machine learning model 208. For example, a measure of a proportion of model 208 outputs that satisfy a rule, or a ratio of classifications by the model 208 across a number of classes, and/or other measures as will be apparent to those skilled in the art.

The model management component 204 further includes an adjuster component 216 as a hardware, software, firmware or combination component arranged to conditionally adjust the software application 206 responsive to the measure of fitness determined by the rule executer 214 and with reference to a predetermined fitness threshold 218. The fitness threshold 218 can be a determinative criterion such as “fit” or “unfit”, and/or can include one or more threshold measures such as threshold rates, proportions, ratios or other measures as will be apparent to those skilled in the art. Thus, the fitness threshold 218 can include one or more indicators of insufficient fitness and/or sufficient fitness of the machine learning model 208 based on the results of executing the rules 202. The adjuster 216 thus selectively adjusts the software application 206 in response to the results of executing the rules 202 and the fitness threshold 218.

Adjustments to the application 206 are made such that a measure of fitness of the machine learning model meets a predetermined threshold measure to indicate sufficient fitness, such as a threshold indicated by the fitness threshold 218. Adjustments to the application 206 by the adjuster 216 can include, inter alia, for example: retraining the machine learning model 208 such as by resetting the model 208 and training the model from scratch using training data such as new training data provided subsequent to a previous training of the model 208; replacing the machine learning model such as by selecting or defining a new machine learning model that may employ the same, similar or different machine learning algorithm for training as a replacement to model 208; further training the machine learning model 208 such as by constructively training the model 208 based on additional training data such as training data provided, generated or identified subsequent to a previous training of the model 208; and identifying the machine learning model 208 as unfit.

In some embodiments, the model management 204 is operable continuously such that the rules 202 are executed based on data retrieved on a regular, periodic, or otherwise repeated basis in order to detect when a measure of fitness of the machine learning model 208 indicates insufficient fitness and take remedial action by adjusting the application 206. Further, in some embodiments the fitness rules 202 are adjustable over time such as to reflect adjustments to the fitness specification 200 such that the requirement for fitness of the machine learning mode 208 are adjusted over time to continually verify the fitness of the machine learning model 208 and to respond to a determination of insufficient fitness by adjustment of the application 206.

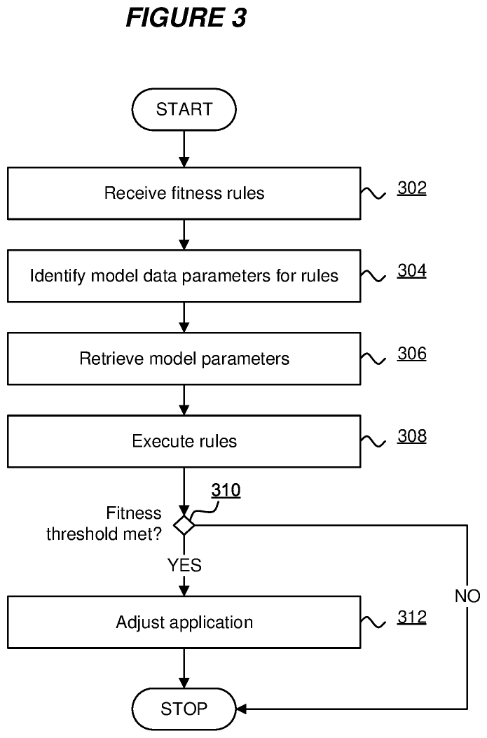

FIG. 3 is a flowchart of a method to operate a software application 206 in accordance with embodiments of the present disclosure. Initially, at 302, the method receives the fitness rules 202. At 304 the method identifies model data parameters derivable from the machine learning model 208 required for execution of the rules 202. At 306 the method retrieves the model parameters. At 308 the rules 202 are executed and, responsive to a determination at 310 that the fitness threshold 218 is met, the method adjusts the application 206 at 312 such that a measure of fitness of the machine learning model 208 meets a threshold measure to indicate sufficient fitness.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the claims.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method for operating a software application including a trained machine learning model, the method comprising:
receiving one or more rules for measuring a fitness of the machine learning model according to a predetermined specification of fitness;
identifying one or more model data parameters derivable from the machine learning model required for execution of the one or more rules;
retrieving the identified one or more model data parameters;
executing the one or more rules to determine a measure of fitness of the machine learning model; and
responsive to a determination that the measure of fitness meets a predetermined threshold measure to indicate insufficient fitness, performing one or more adjustments to the software application such that a measure of fitness of the machine learning model meets a predetermined threshold measure to indicate sufficient fitness.

2. The method of claim 1, wherein adjusting the software application includes one of: retraining the machine learning model; replacing the machine learning model; further training the machine learning model; or identifying the machine learning model as unfit.

3. The method of claim 1, wherein the one or more rules are adapted periodically.

4. The method of claim 1, wherein the model data parameters include one or more of: outputs of the machine learning model; inputs and outputs of the machine learning model; or characteristics of the machine learning model.

5. A computer system comprising:
a processor and memory storing computer program code for operating a software application including a trained machine learning model by:
receiving one or more rules for measuring a fitness of the machine learning model according to a predetermined specification of fitness;
identifying one or more model data parameters derivable from the machine learning model required for execution of the one or more rules;
retrieving the identified one or more model data parameters;
executing the one or more rules to determine a measure of fitness of the machine learning model; and
responsive to a determination that the measure of fitness meets a predetermined threshold measure to indicate insufficient fitness, performing one or more adjustments to the software application such that a measure of fitness of the machine learning model meets a predetermined threshold measure to indicate sufficient fitness.

6. A non-transitory computer-readable storage element comprising computer program code to, when loaded into a computer system and executed thereon, cause the computer system to operate a software application including a trained machine learning model by:
receiving one or more rules for measuring a fitness of the machine learning model according to a predetermined specification of fitness;
identifying one or more model data parameters derivable from the machine learning model required for execution of the one or more rules;
retrieving the identified one or more model data parameters;
executing the one or more rules to determine a measure of fitness of the machine learning model; and
responsive to a determination that the measure of fitness meets a predetermined threshold measure to indicate insufficient fitness, performing one or more adjustments to the software application such that a measure of fitness of the machine learning model meets a predetermined threshold measure to indicate sufficient fitness.
